(19) United States
(12) Patent Application Publication
(10) Pub. No.: US 2026/0195954 A1
(43) Pub. Date: Jul. 9, 2026

(54) DATA-DRIVEN MODELING OF SECONDARY MOTION DYNAMICS USING GAUSSIAN SPLATTING

(71) Applicants: DISNEY ENTERPRISES, INC., Burbank, CA (US); ETH Zürich (Eidgenössische Technische Hochschule Zürich), Zürich (CH)

(72) Inventors: Derek Edward BRADLEY, Zürich (CH); Sebastian Klaus WEISS, Zürich (CH); Prashanth CHANDRAN, Zürich (CH); Gaspard ZOSS, Zürich (CH); Irene BAEZA ROJO, Zürich (CH); Yitong XIA, Zürich (CH)

(21) Appl. No.: 19/011,326

(22) Filed: Jan. 6, 2025

(51) Int. Cl. G06T 13/40; G06T 19/20

(52) U.S. Cl. CPC G06T 13/40; G06T 19/20; G06T 2219/2004; G06T 2219/2012; G06T 2219/2016

(57) ABSTRACT

The present invention sets forth techniques for predicting motion in a 3D model. The disclosed techniques include receiving one or more Gaussian primitives representing a 3D scene and receiving one or more control inputs describing one or more primary motions associated with one or more objects. The techniques also include generating, via a first trained machine learning model, a dynamic state based on the one or more control inputs, and generating, via a second trained machine learning model, one or more deformed Gaussian primitives based on the dynamic state and the one or more Gaussian primitives. The techniques further include generating a 2D representation of the 3D scene, and generating an output sequence based on the 2D representation, wherein the output sequence depicts both the primary motions associated with the one or more objects and one or more secondary motions associated with the one or more objects.

### BACKGROUND

### Field of the Various Embodiments

Embodiments of the present disclosure relate generally to computer animation and, more specifically, to techniques for modeling secondary motion dynamics in an animated representation of a 3D character model.

### Description of the Related Art

Animating a digital avatar or other 3D character model is a common task in computer animation. Animating a 3D character model requires a visually realistic and computationally efficient representation of the character model, as well as accurate predictions of deformation and motion.

Deformation may include quasi-static deformation, based on one-to-one mappings of artistic control inputs to deformations of the 3D character model at a single point in time. Artistic control inputs may include, e.g., explicit motion descriptions of a skeletal structure associated with the 3D character model, simulated muscle actuations in the 3D character model, or the application of one or more blend shapes to the 3D character model. Quasi-static motion, including the motion of limbs, joints, or other simulated features included in the 3D character model, may be referred to as “primary motion.”

Many real-world deformations are dynamic, rather than quasi-static. For example, long hair, loose skin, or baggy clothing may continue to move even after an underlying body motion, such as the movement of a head, limb, or other skeletal feature included in a 3D character model, has ceased. These dynamic, time-dependent deformations may be referred to as “secondary motion.” In many instances, the onset of a secondary motion deformation may also lag behind the underlying body motion. In an example of a 3D character model including a head and long hair, a primary motion that includes rotating the head may cause a delayed secondary motion as the hair follows the motion of the head. After the primary head motion stops, the hair may continue to move briefly before coming to rest.

Existing methods of animating a 3D character model may include a Gaussian splatting technique. These techniques may generate a number of Gaussian splats, attach the splats to an underlying mesh representation of, e.g., a human head, and subsequently deform the underlying mesh to articulate the splats. Gaussian splatting techniques may further include one or more machine learning models, such as multilayer perceptrons (MLPs) that predict positional changes to splats based on artistic control inputs. While these methods may adequately predict primary motion of a 3D character model, they may not be operable to model time-dependent, dynamic secondary motion.

Other existing animation techniques may include a Mixture of Volumetric Primitives (MVP) representation of a 3D scene or 3D character model. These techniques may attempt to model dynamic secondary motion via a statistical analysis of a limited quantity of historical data. For example, these techniques may predict values for a future world state Xₜ₊₁ based on predicted means and standard deviations associated with values included in a previous world state Xₜ. As these techniques incorporate historical data from a limited number of previous world states, they may not accurately predict time-dependent secondary motion over longer time scales.

As the foregoing illustrates, what is needed in the art are more effective techniques for modeling secondary motion dynamics in 3D character models.

### SUMMARY

One embodiment of the present invention sets forth a technique for predicting motion in a 3D model, the computer-implemented method comprising receiving one or more Gaussian primitives representing a 3D scene including one or more objects and receiving one or more control inputs describing one or more primary motions associated with the one or more objects. The technique also includes generating, via a first trained machine learning model, a dynamic state based on the one or more control inputs, generating, via a second trained machine learning model, one or more deformed Gaussian primitives based on the dynamic state and the one or more Gaussian primitives, and generating, via a renderer, a 2D representation of the 3D scene based on the one or more deformed Gaussian primitives and a virtual camera viewpoint. The technique further includes generating an output sequence based at least on the 2D representation, wherein the output sequence depicts both the one or more primary motions associated with the one or more objects and one or more secondary motions associated with the one or more objects.

One technical advantage of the disclosed techniques relative to the prior art is that the disclosed techniques are operable to predict both primary and secondary motion associated with a 3D character model. Further, the disclosed techniques include one or more machine learning models that incorporate time-varying hidden states representing historical dynamic kinematic control inputs, allowing for more accurate prediction of dynamic secondary motion over longer time scales. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the training engine of FIG. 1, according to some embodiments.

FIG. 3 is a flow diagram of method steps for training one or more machine learning models, according to some embodiments.

FIG. 4 is a more detailed illustration of the inference engine of FIG. 1, according to some embodiments.

FIG. 5 is a flow diagram of method steps for predicting motion in a 3D character model, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

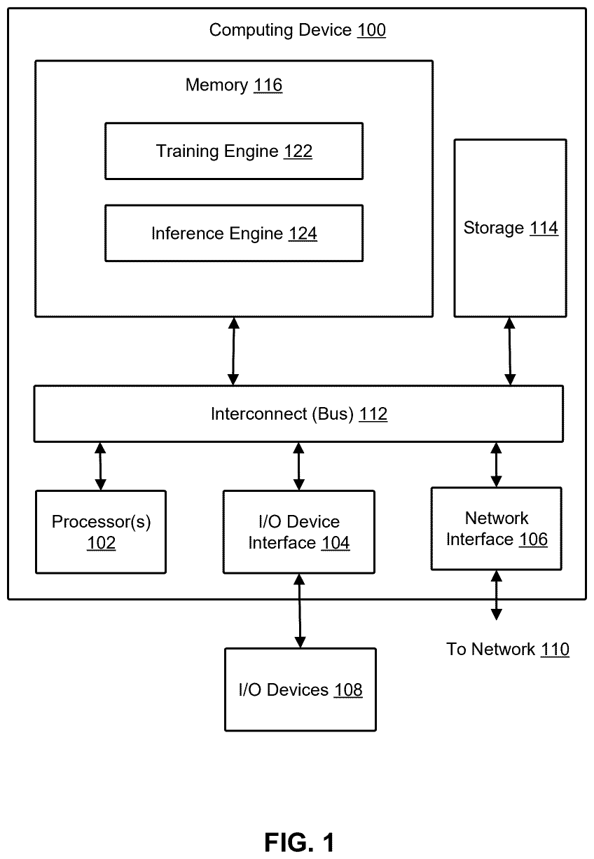

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an inference engine 124 that reside in a memory 116.

It is noted that the computing device described herein is illustrative and that any other technically feasible configurations fall within the scope of the present disclosure. For example, multiple instances of training engine 122 or inference engine 124 could execute on a set of nodes in a distributed and/or cloud computing system to implement the functionality of computing device 100. In another example, training engine 122 or inference engine 124 could execute on various sets of hardware, types of devices, or environments to adapt training engine 122 or inference engine 124 to different use cases or applications. In a third example, training engine 122 or inference engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and inference engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 or inference engine 124.

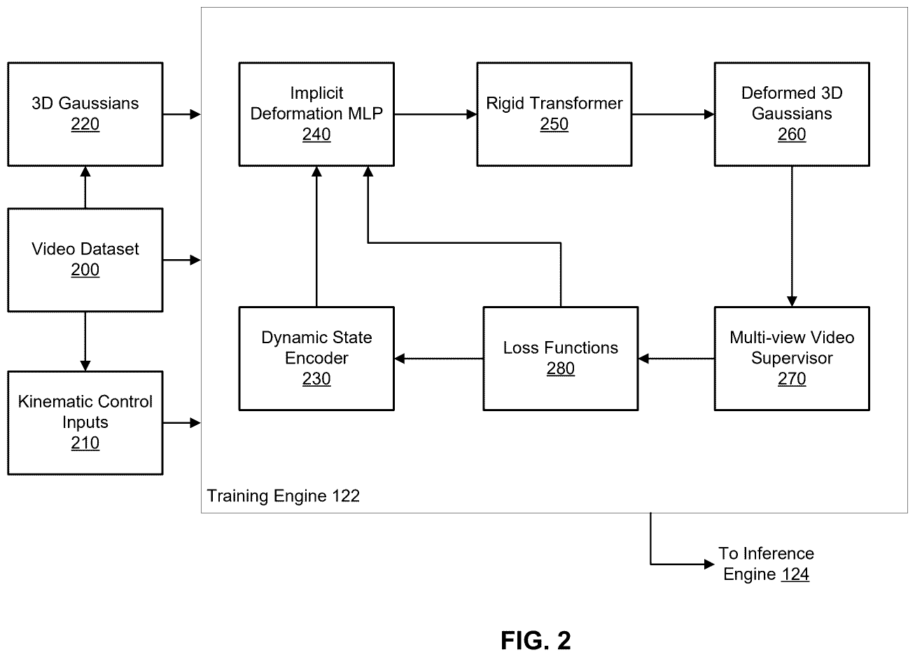

FIG. 2 is a more detailed illustration of training engine 122 of FIG. 1, according to some embodiments. Training engine 122 trains one or more machine learning models to generate a novel performance associated with a 3D character model, where the novel performance includes both quasi-static primary motion of the 3D character model and dynamic secondary motion of the 3D character model. In various embodiments, the 3D character model may include a representation of an actor's face, head, or full body. Training engine 122 receives video dataset 200, kinematic control inputs 210, and 3D Gaussians 220, and transmits one or more trained machine learning models to inference engine 124 discussed below. Training engine 122 includes, without limitation, dynamic state encoder 230, implicit deformation Multilayer Perceptron (MLP) 240, rigid transformer 250, world 3D Gaussians 260, multi-view video supervisor 270, and loss functions 280.

Video dataset 200 includes a recorded video performance of an actor, where the recorded video performance includes one or more frames. Each of the one or more frames includes one or multiple views of the actor captured from different viewpoints associated with multiple cameras. In various embodiments, each of the multiple views may depict the actor's face, head, or full body. Video dataset 200 may also include a frame depicting the actor in a neutral position, e.g., centered in the frame and including a neutral facial expression.

The recorded video performance may include both quasi-static primary motion and dynamic secondary motion. Primary motion may include the motion of the actor's skull, joint, limb, or other bodily feature. Secondary motion may include the motion of soft, flexible, or otherwise deformable actor features, such as hair, loose skin, or baggy clothing. The secondary motion of a deformable actor feature may be influenced by the primary motion of one or more actor features, such as hair or loose facial skin moving in response to a movement of the actor's skull. The secondary motion may lag behind the influencing primary motion. For example, the movement of hair or loose facial skin associated with a movement of the actor's skull may commence shortly after a movement of the actor's skull, and may continue for a period of time after the movement of the actor's skull has ceased.

Kinematic control inputs 210 include one or more per-frame control inputs associated with each frame of the recorded video performance included in video dataset 200 and describing the primary motion of the actor. For example, kinematic control inputs 210 may include a skull velocity, a rigid skull transformation, and/or an encoded facial expression associated with a frame of the recorded video performance. Various embodiments of the present invention may generate the one or more per-frame control inputs based on an automated analysis of the recorded video performance.

3D Gaussians 220 include multiple Gaussian primitives, or splats, that collectively form a 3D representation of a scene, e.g., the actor's face, head, or body. In various embodiments, 3D Gaussians 220 represent the actor in a canonical space, having a neutral, undeformed position, e.g., centered in the 3D representation, and having a neutral, undeformed facial expression. Each 3D Gaussian i of 3D Gaussians 220 includes corresponding parameters xᵢ, where parameters xᵢ include a position p, a scale s, a rotation r, a color c, and an opacity o. The parameters xᵢ associated with the multiple 3D Gaussians are combined into a 2D matrix X having a length and a width based on the number of 3D Gaussians and the number of parameters per 3D Gaussian. Training engine 122 receives video dataset 200, kinematic control inputs 210, and 3D Gaussians 220.

Dynamic state encoder 230 of training engine 122 receives a history of control inputs included in kinematic control inputs 210 and predicts a dynamic state y corresponding to a frame t included in video dataset 200, based on the history of control inputs. The dynamic state y describes the dynamic motion of the actor associated with frame t.

At frame t, vector zₜ includes an arbitrarily-defined vector encoding of dynamic kinematic controls included in kinematic control inputs 210 and associated with frame t. In various embodiments, this vector encoding may include, but is not limited to, skeleton controls, blend shapes associated with facial expressions, muscle actuations, or a template mesh representing underlying deformed skin. Vector encoding zₜ defines the quasi-static configuration of the actor motion during frame t.

In some embodiments, dynamic state encoder 230 includes a multilevel perceptron (MLP) neural network encoder. In these embodiments, vector encoding zₜ of the control inputs may include a simple concatenation of control inputs associated with a historical time window of n frames, such that vector encoding zₜ=[c0, c1, c2, . . . cn]. Dynamic state encoder 230 generates dynamic state y based on the concatenated control inputs.

In other embodiments, dynamic state encoder 230 includes a transformer network. In these embodiments, training engine 122 provides each of the per-frame control inputs c0, c1, c2, . . . cn included in zₜ as separate input tokens to dynamic state encoder 230. Dynamic state encoder 230 generates dynamic state y based on the individual input tokens via an attention mechanism as is known in the art.

In yet other embodiments, dynamic state encoder 230 includes a recurrent neural network (RNN) or long short-term memory (LSTM) neural network. In these embodiments, dynamic state encoder 230 receives current control inputs ci associated with a single frame included in a series of n frames, where i=(0:n). Dynamic state encoder 230 also includes a hidden state h representing the history of control inputs. Training engine 122 initializes hidden state h to zero when processing control inputs c0 associated with a first frame. While processing each subsequent frame, dynamic state encoder generates dynamic state y based on control inputs ci and hidden state h. Dynamic state encoder 230 also generates an updated value for hidden state h, and feeds the updated hidden state h back into dynamic state encoder 230 as a recurrent input when processing the next frame in the series of frames.

In each of the above embodiments, dynamic state encoder 230 transmits the generated per-frame dynamic state y to implicit deformation multiplayer perceptron (MLP) 240. Implicit deformation MLP 240 processes each 3D Gaussian included in 3D Gaussians 220 and associated with a frame t, and generates delta values ∂x, i.e., modifications, to be applied to the Gaussian parameters in frame t+1. As discussed above, the Gaussian parameters associated with each 3D Gaussian may include a position p, a scale s, a rotation r, a color c, and an opacity o. Implicit deformation MLP 240 receives as input dynamic state y and a

position p associated with a 3D Gaussian included in 3D Gaussians 220. The position p indicates a location in canonical space where training engine 122 is to evaluate implicit deformation MLP 240. Implicit deformation MLP 240 includes an embedding network that projects the position p into a higher-dimensional latent space. In various embodiments, the embedding network is learnable and includes one or more adjustable internal parameters. Implicit deformation MLP 240 also includes a series of M linear layers, where each linear layer includes an activation function. Training engine 122 applies the per-frame dynamic state y to each of the M linear layers. Each of the M linear layers sequentially concatenates or modulates the higher-dimensional latent representation of position p with the dynamic state y. The Mth linear layer transmits its modulated output to a final linear layer having an output activation function. The output of implicit deformation MLP 240 includes delta values ∂x to be applied to the 3D Gaussian parameters in subsequent frame t+1. After implicit deformation MLP 240 processes all of the 3D Gaussians included in 3D Gaussians 220 and associated with a single frame, implicit deformation MLP 240 generates an output including a collection of deformed 3D Gaussians expressed in canonical space. Training engine 122 transmits the collection of deformed 3D Gaussians to rigid transformer 250. In one or more alternate embodiments, training engine 122 may indirectly

deform groups of Gaussian primitives, rather than deforming each Gaussian primitive directly. In these embodiments, training engine 122 determines a set of anchors located in the same canonical space as the Gaussian primitives included in 3D Gaussians 220, and associates a predetermined number, e.g., ten, of the Gaussian primitives with each anchor. In various embodiments, training engine 122 may initialize the anchor positions and associate Gaussian primitives with each anchor using any suitable space-filling discretization technique. In these embodiments, training engine 122 optimizes the Gaussian parameters for individual Gaussian primitives (position p, scale s, rotation r, color c, and opacity o) such that the optimized Gaussian parameter values for individual Gaussian primitives remain constant over multiple frames included in video dataset 200. In these embodiments, implicit deformation MLP 240 may generate scale, rotation, and translation deformation values for each anchor, rather than for each individual Gaussian primitive. Each individual Gaussian primitive is then scaled, rotated, and/or translated based on the deformation values generated for its associated anchor.

Rigid transformer 250 applies one or more rigid transformations to the collection of deformed 3D Gaussians received from implicit deformation MLP 240. The one or more rigid transformations translate the deformed 3D Gaussians from canonical space into a world space. Rigid transformations include transformations that do not change the size of shape of objects represented by the deformed 3D Gaussians. Examples of rigid transformations may include rotation, translation, or reflection. Rigid transformer 250 applies the one or more rigid transformations to each 3D Gaussian included in the deformed 3D Gaussians received from implicit deformation MLP 240 and generates world 3D Gaussians 260.

World 3D Gaussians 260 includes a representation of a 3D scene including multiple 3D Gaussians each having an associated position p expressed in world space coordinates. In various embodiments, the 3D scene may include an actor's face, head, or full body. Training engine 122 transmits world 3D Gaussians 260 to multi-view video supervisor 270.

Multi-view video supervisor 270 includes one or more cameras, where each of the one or more cameras includes an associated viewpoint expressed in the world coordinate system. Each viewpoint may include a world space position associated with the camara and a viewing direction from the camera to the 3D scene represented by world 3D Gaussians 260. In various embodiments, the viewpoints associated with each camera included in multi-view video supervisor 270 may correspond to a viewpoint associated with a camera used to capture one of multiple views included in video dataset 200. Training engine 122 projects world 3D Gaussians 260 onto multiple image planes, where each image plane is based on a viewpoint associated with a camera included in multi-view video supervisor 270. Each of the multiple projections includes a 2D depiction of the 3D scene represented by world 3D Gaussians 260. Each of the multiple 2D depictions may include a raster image including a 2D arrangement of multiple pixels, where each pixel includes multiple values, such as color or opacity values. Training engine 122 transmits the multiple projections to loss functions 280.

Loss functions 280 include one or more loss functions that evaluate the similarity between a projection of a 3D scene received from multi-view video supervisor 270 and a corresponding depiction of the scene included in video dataset 200. In various embodiments, a projection received from multi-view video supervisor 270 corresponds to a specific frame included in video dataset 200, and training engine 122 evaluates the one or more loss functions based on the projection and a corresponding viewpoint included in the specific frame of video dataset 200. A loss function value calculated for one of loss functions 280 may include a summation of per-pixel differences between pixels included in the projection and corresponding pixels included in the corresponding frame of video dataset 200. The frames included in video dataset 200 depict both primary and secondary motion of the actor. Consequently, loss functions 280 are operable to evaluate the ability of dynamic state encoder 230 and implicit deformation MLP 240 to generate 3D Gaussian representations that capture both primary and secondary actor motions.

Based on values calculated for one or more of loss functions 280, training engine 122 modifies one or more adjustable internal parameters included in dynamic state encoder 230 and/or implicit deformation MLP 240. In various embodiments, dynamic state encoder 230 and implicit deformation MLP 240 may be trained in an end-to-end manner, such as via backpropagation. After modifying the one or more adjustable internal parameters, training engine 122 retrieves the next frame included in video dataset 200 and continues the training process. Training engine 122 may continue the training process until a predetermined number of frames have been processed, until all of the frames included in video dataset 200 have been processed, or until one or more loss function values associated with loss functions 280 are below one or more predetermined thresholds. After training, training engine 122 transmits trained implicit deformation MLP 240 and trained dynamic state encoder 230 to inference engine 124 discussed below.

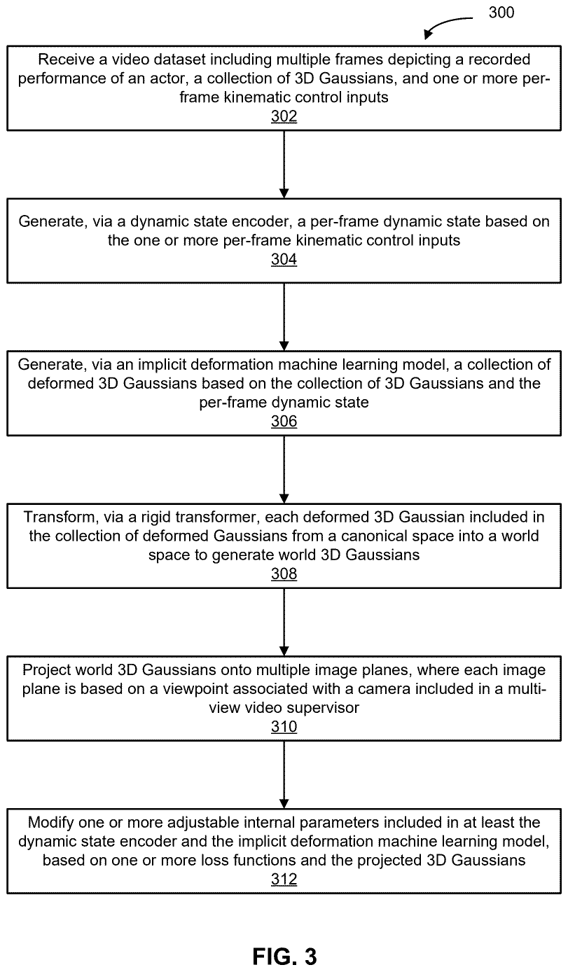

FIG. 3 is a flow diagram of method steps for training one or more machine learning models, according to some embodiments. Although the method steps are described in conjunction with the systems of FIGS. 1-2, persons skilled in the art will understand that any system configured to perform the method steps in any order falls within the scope of the present disclosure.

As shown, in step 302 of method 300, training engine 122 receives video dataset 200, kinematic control inputs 210, and 3D Gaussians 220. Video dataset 200 includes a recorded video performance of an actor, where the recorded video performance includes one or more frames. Each of the one or more frames includes multiple views of the actor captured from different viewpoints associated with multiple cameras. In various embodiments, each of the multiple views may depict the actor's face, head, or full body. Video dataset 200 may also include a frame depicting the actor in a neutral position, e.g., centered in the frame and including a neutral facial expression.

The recorded video performance may include both quasi-static primary motion and dynamic secondary motion. Primary motion may include the motion of the actor's skull, joint, limb, or other bodily feature. Secondary motion may include the motion of soft, flexible, or otherwise deformable actor features, such as hair, loose skin, or baggy clothing. The secondary motion of a deformable actor feature may be influenced by the primary motion of one or more actor features, such as hair or loose facial skin moving in response to a movement of the actor's skull. The secondary motion may lag behind the influencing primary motion. For example, the movement of hair or loose facial skin associated with a movement of the actor's skull may commence shortly after a movement of the actor's skull, and may continue for a period of time after the movement of the actor's skull has ceased.

Kinematic control inputs 210 include one or more per-frame control inputs associated with each frame of the recorded video performance included in video dataset 200 and describing the primary motion of the actor. For example, kinematic control inputs 210 may include a skull velocity, a rigid skull transformation, and/or an encoded facial expression associated with a frame of the recorded video performance. Various embodiments of the present invention may generate the one or more per-frame control inputs based on an automated analysis of the recorded video performance included in video dataset 200.

3D Gaussians 220 include multiple Gaussian primitives, or splats, that collectively form a 3D representation of a scene, e.g., the actor's face, head, or body. In various embodiments, 3D Gaussians 220 represent the actor in a canonical space, having a neutral, undeformed position, e.g., centered in the 3D representation, and having a neutral, undeformed facial expression. Each 3D Gaussian i of 3D Gaussians 220 includes corresponding parameters xᵢ, where parameters xᵢ include a position p, a scale s, a rotation r, a color c, and an opacity o. The parameters xᵢ associated with the multiple 3D Gaussians are combined into a 2D matrix X having a length and a width based on the number of 3D Gaussians and the number of parameters per 3D Gaussian. Training engine 122 receives video dataset 200, kinematic control inputs 210, and 3D Gaussians 220.

In step 304, dynamic state encoder 230 of training engine 122 predicts a dynamic state y corresponding to a frame t included in video dataset 200, based on the history of control inputs. The dynamic state y describes the dynamic motion of the actor associated with frame t.

At frame t, vector zₜ includes an arbitrarily-defined vector encoding of dynamic kinematic controls included in kinematic control inputs 210 and associated with frame t. In various embodiments, this vector encoding may include, but is not limited to, skeleton controls, blend shapes associated with facial expressions, muscle actuations, or a template mesh representing underlying deformed skin. Vector encoding zₜ defines the quasi-static configuration of the actor motion during frame t. Dynamic state encoder 230 transmits the generated per-frame dynamic state y to implicit deformation multiplayer perceptron (MLP) 240.

In step 306, Implicit deformation MLP 240 processes each 3D Gaussian included in 3D Gaussians 220 and associated with a frame t, and generates delta values ∂x, i.e., modifications, to be applied to the Gaussian parameters in frame t+1. The Gaussian parameters associated with each 3D Gaussian may include a position p, a scale s, a rotation r, a color c, and an opacity o. Implicit deformation MLP 240 receives as input dynamic state y and a

position p associated with a 3D Gaussian included in 3D Gaussians 220. The position p indicates a location in canonical space where training engine 122 is to evaluate implicit deformation MLP 240. Implicit deformation MLP 240 includes an embedding network that projects the position p into a higher-dimensional latent space. In various embodiments, the embedding network is learnable and includes one or more adjustable internal parameters. Implicit deformation MLP 240 also includes a series of M linear layers, where each linear layer includes an activation function. Training engine 122 applies the per-frame dynamic state y to each of the M linear layers. Each of the M linear layers sequentially concatenates or modulates the higher-dimensional latent representation of position p with the dynamic state y. The Mth linear layer transmits its modulated output to a final linear layer having an output activation function. The output of implicit deformation MLP 240 includes delta values ∂x to be applied to the 3D Gaussian parameters in subsequent frame t+1. After implicit deformation MLP 240 processes all of the 3D Gaussians included in 3D Gaussians 220 and associated with a single frame, implicit deformation MLP 240 generates an output including a collection of deformed 3D Gaussians expressed in canonical space. Training engine 122 transmits the collection of deformed 3D Gaussians to rigid transformer 250. In one or more alternate embodiments, training engine 122 may indirectly

deform groups of Gaussian primitives, rather than deforming each Gaussian primitive directly. In these embodiments, training engine 122 determines a set of anchors located in the same canonical space as the Gaussian primitives included in 3D Gaussians 220, and associates a predetermined number, e.g., ten, of the Gaussian primitives with each anchor. In various embodiments, training engine 122 may initialize the anchor positions and associate Gaussian primitives with each anchor using any suitable space-filling discretization technique. In these embodiments, training engine 122 optimizes the Gaussian parameters for individual Gaussian primitives (position p, scale s, rotation r, color c, and opacity o) such that the optimized Gaussian parameter values for individual Gaussian primitives remain constant over multiple frames included in video dataset 200. In these embodiments, implicit deformation MLP 240 may generate scale, rotation, and translation deformation values for each anchor, rather than for each individual Gaussian primitive. Each individual Gaussian primitive is then scaled, rotated, and/or translated based on the deformation values generated for its associated anchor.

In step 308, rigid transformer 250 of training engine 122 applies one or more rigid transformations to the collection of deformed 3D Gaussians received from implicit deformation MLP 240. The one or more rigid transformations translate the deformed 3D Gaussians from canonical space into a world space. Rigid transformations include transformations that do not change the size of shape of objects represented by the deformed 3D Gaussians. Examples of rigid transformations may include rotation, translation, or reflection. Rigid transformer 250 applies the one or more rigid transformations to each 3D Gaussian included in the deformed 3D Gaussians received from implicit deformation MLP 240 and generates world 3D Gaussians 260.

World 3D Gaussians 260 includes a representation of a 3D scene including multiple 3D Gaussians each having an associated position p expressed in world space coordinates. In various embodiments, the 3D scene may include an actor's face, head, or full body. Training engine 122 transmits world 3D Gaussians 260 to multi-view video supervisor 270.

In step 310, training engine 122 projects world 3D Gaussians 260 onto multiple image planes, where each image plane is based on a viewpoint associated with a camera included in multi-view video supervisor 270. Multi-view video supervisor 270 includes one or more cameras, where each of the one or more cameras includes an associated viewpoint expressed in the world coordinate system. Each viewpoint may include a world space position associated with the camara and a viewing direction from the camera to the 3D scene represented by world 3D Gaussians 260. In various embodiments, the viewpoints associated with each camera included in multi-view video supervisor 270 may correspond to a viewpoint associated with a camera used to capture one of multiple views included in video dataset 200. Each of the multiple projections includes a 2D depiction of the 3D scene represented by world 3D Gaussians 260. Each of the multiple 2D depictions may include a raster image including a 2D arrangement of multiple pixels, where each pixel includes multiple values, such as color or opacity values. Training engine 122 transmits the multiple projections to loss functions 280.

In step 312, training engine 122 modifies one or more adjustable internal parameters included in dynamic state encoder 230 and/or implicit deformation MLP 240 based on values calculated for one or more of loss functions 280. Loss functions 280 include one or more loss functions that evaluate the similarity between a projection of a 3D scene received from multi-view video supervisor 270 and a corresponding depiction of the scene included in video dataset 200. In various embodiments, a projection received from multi-view video supervisor 270 corresponds to a specific frame included in video dataset 200, and training engine 122 evaluates the one or more loss functions based on the projection and a corresponding viewpoint included in the specific frame of video dataset 200. A loss function value calculated for one of loss functions 280 may include a summation of per-pixel differences between pixels included in the projection and corresponding pixels included in the corresponding frame of video dataset 200. The frames included in video dataset 200 depict both primary and secondary motion of the actor. Consequently, loss functions 280 are operable to evaluate the ability of dynamic state encoder 230 and implicit deformation MLP 240 to generate 3D Gaussian representations that capture both primary and secondary actor motions.

In various embodiments, dynamic state encoder 230 and implicit deformation MLP 240 may be trained in an end-to-end manner, such as via backpropagation. After modifying the one or more adjustable internal parameters, training engine 122 retrieves the next frame included in video dataset 200 and continues the training process. Training engine 122 may continue the training process until a predetermined number of frames have been processed, until all of the frames included in video dataset 200 have been processed, or until one or more loss function values associated with loss functions 280 are below one or more predetermined thresholds. After training, training engine 122 transmits trained implicit deformation MLP 240 and trained dynamic state encoder 230 to inference engine 124.

In various embodiments, training engine 122 may process multiple frames included in video dataset 200, as well as multiple per-frame kinematic control inputs 210. Consequently, training engine 122 may repeatedly execute one or more of steps 302, 304, 306, 308, 310, or 312 included in method 300.

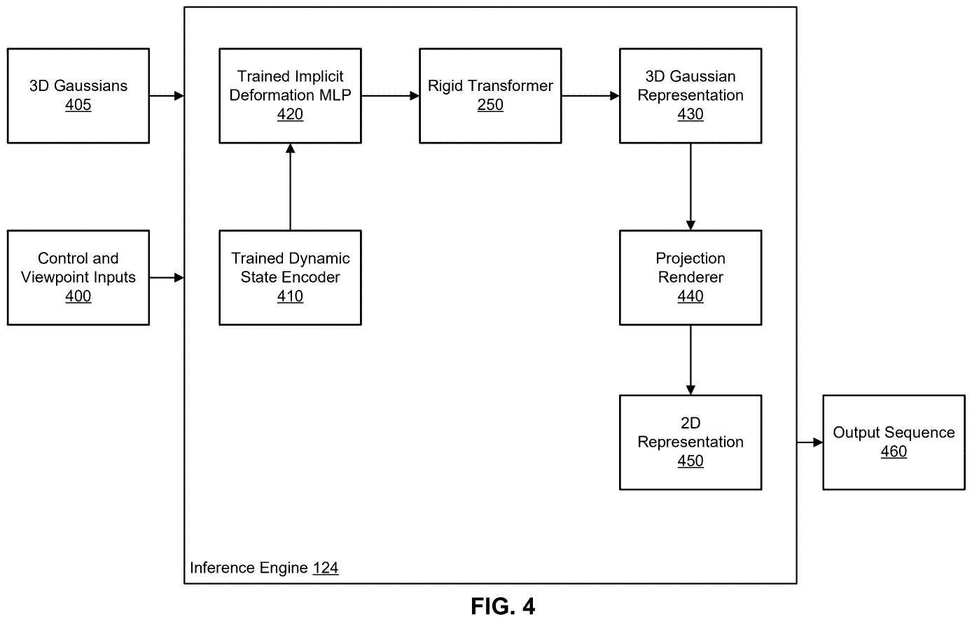

FIG. 4 is a more detailed illustration of inference engine 124 of FIG. 1, according to some embodiments. Inference engine 124 generates output sequence 460 that includes a novel actor performance depicting both primary and secondary actor motion. Inference engine 124 generates output sequence 460 based on control and viewpoint inputs 400 and 3D Gaussians 405. Inference engine 124 includes, without limitation, trained dynamic state encoder 410, trained implicit deformation MLP 420, rigid transformer 250, 3D Gaussian representation 430, projection renderer 440, and 2D representation 450.

Control and viewpoint inputs 400 include, for each of multiple frames, one or more user-specified primary motion control inputs associated with the frame and a camera viewpoint associated with the frame. Each of the one or more primary motion control inputs may include, for example, a velocity associated with a skull or other feature included in a 3D character model, a rigid transformation associated with a joint, limb, or other feature included in the 3D character model, and/or a latent encoding of a facial expression associated with the 3D character model. In various embodiments, the one or more primary motion control inputs may be handcrafted by a user or reconstructed from a recorded video performance of the actor depicted in video dataset 200 discussed above in the description of FIG. 2. The one or more primary motion control inputs may also be reconstructed from a recorded video performance of a different actor than the actor depicted in video dataset 200.

The camera viewpoint may include a location of a virtual camera within a 3D world coordinate space and a viewing direction from the virtual camera to a location within a 3D scene that includes the 3D character model. Inference engine 124 transmits the one or more primary motion control inputs associated with a current frame and one or more historical frames to trained dynamic state encoder 410 discussed below. Inference engine 124 transmits the camera viewpoint associated with the frame to projection renderer 440 discussed below.

3D Gaussians 405 include multiple Gaussian primitives, or splats, that collectively form a 3D representation of a scene, e.g., an actor's face, head, or body. In various embodiments, 3D Gaussians 405 represent the actor in a canonical space, having a neutral, undeformed position, e.g., centered in the 3D representation, and having a neutral, undeformed facial expression. Each 3D Gaussian i of 3D Gaussians 405 includes corresponding parameters xᵢ, where parameters xᵢ include a position p, a scale s, a rotation r, a color c, and an opacity o. The parameters xᵢ associated with the multiple 3D Gaussians are combined into a 2D matrix X having a length and a width based on the number of 3D Gaussians and the number of parameters per 3D Gaussian.

Trained dynamic state encoder 410 receives a history of per-frame primary motion control inputs included in control and viewpoint inputs 400 and predicts, based on the history of per-frame primary motion control inputs, a dynamic state y corresponding to a frame t to be generated, where per-frame control inputs associated with the frame t are included in control and viewpoint inputs 400. The dynamic state y describes the dynamic motion of the actor associated with frame t.

In various embodiments, the architecture and operation of trained dynamic state encoder 410 may be identical or substantially identical to the architecture and operation of dynamic state encoder 230 discussed above in the description of FIG. 2. Similar to dynamic state encoder 230, various embodiments of trained dynamic state encoder 410 may include a machine learning model, such as a multilevel perceptron (MLP) neural network encoder, a transformer network, a recurrent neural network (RNN), or a long short-term memory (LSTM) neural network. Trained dynamic state encoder 410 may process one or more per-frame primary motion control inputs via one of the various architectures described above and generate a dynamic state y. Trained dynamic state encoder 410 transmits the dynamic state y to trained implicit deformation MLP 420.

Trained implicit deformation MLP 420 receives 3D Gaussians 405 and the dynamic state y generated by trained dynamic state encoder 410. Trained implicit deformation MLP 420 processes each 3D Gaussian included in 3D Gaussians 405 and associated with a frame t, and generates delta values ∂x, i.e., modifications, to be applied to the Gaussian parameters in frame t+1. As discussed above, the Gaussian parameters associated with each 3D Gaussian may include a position p, a scale s, a rotation r, a color c, and an opacity o. Trained implicit deformation MLP 420 receives as input a position p

associated with a 3D Gaussian included in 3D Gaussians 405. The position p indicates a location in canonical space where inference engine 124 is to evaluate trained implicit deformation MLP 420. Trained implicit deformation MLP 420 includes an embedding network that projects the position p into a higher-dimensional latent space. In various embodiments, the embedding network is learnable, and includes one or more adjustable internal parameters. Trained implicit deformation MLP 420 also includes a series of M linear layers, where each linear layer includes an activation function. Inference engine 124 applies the per-frame dynamic state y to each of the M linear layers. Each of the M linear layers sequentially concatenates or modulates the higher-dimensional latent representation of position p with the dynamic state y. The Mth linear layer transmits its modulated output to a final linear layer having an output activation function. The output of trained implicit deformation MLP 420 includes delta values ∂x to be applied to the 3D Gaussian parameters in subsequent frame t+1. After trained implicit deformation MLP 420 processes all of the 3D Gaussians included in 3D Gaussians 405 and associated with a single frame, trained implicit deformation MLP 420 generates an output including a collection of deformed 3D Gaussians expressed in canonical space. Inference engine 124 transmits the collection of deformed 3D Gaussians to rigid transformer 250. In various embodiments, rigid transformer 250 depicted in FIG. 4 may be an

additional instance of rigid transformer 250 depicted in FIG. 2, and may include a substantially similar architecture. As discussed above in the description of FIG. 2, rigid transformer 250 applies one or more rigid transformations to the collection of deformed 3D Gaussians received from trained implicit deformation MLP 240. The one or more rigid transformations translate the deformed 3D Gaussians from canonical space into a world space. Rigid transformations include transformations that do not change the size of shape of objects represented by the deformed 3D Gaussians. Examples of rigid transformations may include rotation, translation, or reflection. Rigid transformer 250 applies the one or more rigid transformations to each 3D Gaussian included in the deformed 3D Gaussians received from trained implicit deformation MLP 420 and generates 3D Gaussian representation 430.

3D Gaussian representation 430 includes a representation of a 3D scene including multiple 3D Gaussians, each having an associated position p expressed in world space coordinates. In various embodiments, the 3D scene may include an actor's face, head, or full body. Inference engine 124 transmits 3D Gaussian representation 430 to projection renderer 440.

Projection renderer 440 generates a 2D representation 450 of a 3D scene represented by 3D Gaussian representation 430, based on a virtual camera viewpoint included in control and viewpoint inputs 400. As discussed above, a viewpoint includes a location in world space associated with a virtual camera, and a viewing direction from the virtual camera to a location included in the 3D scene. In various embodiments, the viewing direction may include horizontal and vertical angular displacements describing an orientation relative to a default orientation, e.g., a default viewing direction from the virtual camera to a geometric center of the 3D scene.

In various embodiments, 2D representation 450 may include a 2D raster image depicting the 3D scene as viewed from the virtual camera viewpoint included in control and viewpoint inputs 400. 2D representation 450 may include a rectangular arrangement of multiple pixels, where each of the multiple pixels include one or more pixel channels. The pixel channels may include pixel channel values describing characteristics of the associated pixel, such as color or transparency. 2D representation 450 may depict a single frame included in a novel performance of an actor generated by inference engine 124. Inference engine 124 may store 2D representation 450 in, e.g., storage 114, prior to processing the next per-frame inputs included in control and viewpoint inputs 400.

Inference engine 124 generates output sequence 460 based on multiple instances of 2D representation 450 that have been previously generated and stored by inference engine 124. Inference engine 124 generates, for each instance of 2D representation 450, a single frame included in output sequence 460. Output sequence 460 includes an animated sequence depicting the actor for whom trained dynamic state encoder 410 and trained implicit deformation MLP 420 have been previously trained as discussed above in the description of FIG. 2. Each frame included in output sequence 460 depicts both primary and secondary motion of the actor based on the per-frame kinematic control inputs and per-frame camera viewpoint included in control and viewpoint inputs 400.

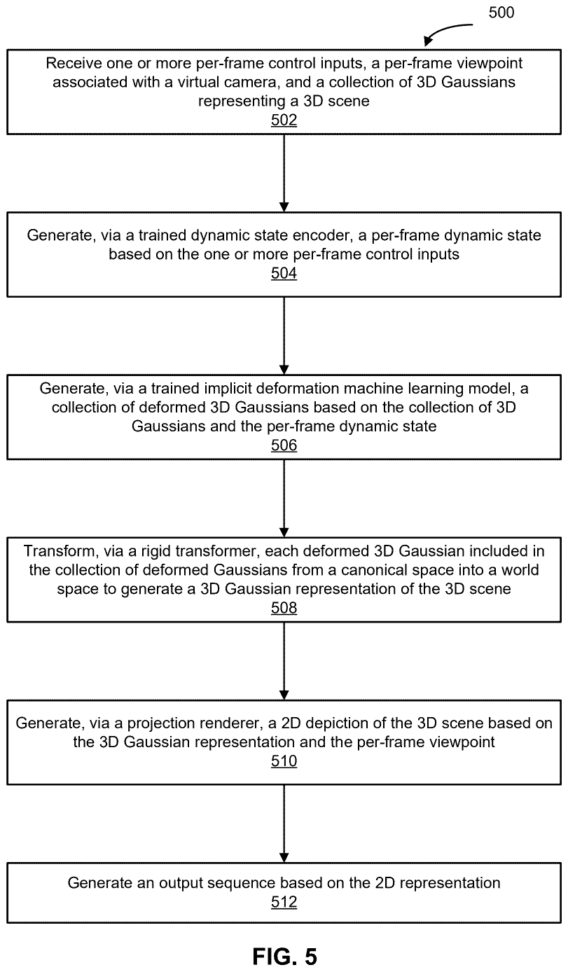

FIG. 5 is a flow diagram of method steps for predicting motion in a 3D character model, according to some embodiments. Although the method steps are described in conjunction with the systems of FIGS. 1-2 and 4, persons skilled in the art will understand that any system configured to perform the method steps in any order falls within the scope of the present disclosure.

As shown, in step 502 of method 500, inference engine 124 receives control and viewpoint inputs 400, including one or more per-frame primary motion control inputs and a camera viewpoint associated with a virtual camera. Each of the one or more primary motion control inputs may include, for example, a velocity associated with a skull or other feature included in a 3D character model, a rigid transformation associated with a joint, limb, or other feature included in the 3D character model, and/or a latent encoding of a facial expression associated with the 3D character model.

The camera viewpoint may include a location of a virtual camera within a 3D world coordinate space and a viewing direction from the virtual camera to a location within a 3D scene that includes the 3D character model. Inference engine 124 transmits the one or more primary motion control inputs associated with a current frame and one or more historical frames to trained dynamic state encoder 410. Inference engine 124 transmits the camera viewpoint associated with the frame to projection renderer 440.

Inference engine 124 also receives a collection of 3D Gaussians 405. 3D Gaussians 405 include multiple Gaussian primitives, or splats, that collectively form a 3D representation of a scene, e.g., an actor's face, head, or body. In various embodiments, 3D Gaussians 405 represent the actor in a canonical space, having a neutral, undeformed position, e.g., centered in the 3D representation, and having a neutral, undeformed facial expression. Each 3D Gaussian i of 3D Gaussians 405 includes corresponding parameters xᵢ, where parameters xᵢ include a position p, a scale s, a rotation r, a color c, and an opacity o. The parameters xᵢ associated with the multiple 3D Gaussians are combined into a 2D matrix X having a length and a width based on the number of 3D Gaussians and the number of parameters per 3D Gaussian.

In step 504, trained dynamic state encoder 410 of inference engine 124 receives a history of per-frame primary motion control inputs included in control and viewpoint inputs 400 and predicts, based on the history of per-frame primary motion control inputs, a dynamic state y corresponding to a frame t to be generated, where per-frame control inputs associated with the frame t are included in control and viewpoint inputs 400. The dynamic state y describes the dynamic motion of the actor associated with frame t, including both primary and secondary motion.

In various embodiments, trained dynamic state encoder 410 may include a machine learning model, such as a multilevel perceptron (MLP) neural network encoder, a transformer network, a recurrent neural network (RNN), or a long short-term memory (LSTM) neural network. Trained dynamic state encoder 410 may process one or more per-frame primary motion control inputs via one of the various architectures described above and generate a dynamic state y. Trained dynamic state encoder 410 transmits the dynamic state y to trained implicit deformation MLP 420.

In step 506, trained implicit deformation MLP 420 of inference engine 124 generates a collection of deformed 3D Gaussians based on 3D Gaussians 405 and the dynamic state y generated by trained dynamic state encoder 410. Trained implicit deformation MLP 420 processes each 3D Gaussian included in 3D Gaussians 405 and associated with a frame t, and generates delta values ∂x, i.e., modifications, to be applied to the Gaussian parameters in frame t+1. As discussed above, the Gaussian parameters associated with each 3D Gaussian may include a position p, a scale s, a rotation r, a color c, and an opacity o. Trained implicit deformation MLP 420 receives as input a position p

associated with a 3D Gaussian included in 3D Gaussians 405. The position p indicates a location in canonical space where inference engine 124 is to evaluate trained implicit deformation MLP 420. Trained implicit deformation MLP 420 includes an embedding network that projects the position p into a higher-dimensional latent space. In various embodiments, the embedding network is learnable, and includes one or more adjustable internal parameters. Trained implicit deformation MLP 420 also includes a series of M linear layers, where each linear layer includes an activation function. Inference engine 124 applies the per-frame dynamic state y to each of the M linear layers. Each of the M linear layers sequentially concatenates or modulates the higher-dimensional latent representation of position p with the dynamic state y. The Mth linear layer transmits its modulated output to a final linear layer having an output activation function. The output of trained implicit deformation MLP 420 includes delta values ∂x to be applied to the 3D Gaussian parameters in subsequent frame t+1. After trained implicit deformation MLP 420 processes all of the 3D Gaussians included in 3D Gaussians 405 and associated with a single frame, trained implicit deformation MLP 420 generates an output including a collection of deformed 3D Gaussians expressed in canonical space. Inference engine 124 transmits the collection of deformed 3D Gaussians to rigid transformer 250. In step 508, rigid transformer 250 translates each deformed 3D Gaussian

received from trained implicit deformation MLP 420 from canonical space into a world space. Rigid transformer 250 applies one or more rigid transformations to the collection of deformed 3D Gaussians received from trained implicit deformation MLP 240. Rigid transformations include transformations that do not change the size of shape of objects represented by the deformed 3D Gaussians. Examples of rigid transformations may include rotation, translation, or reflection. Rigid transformer 250 applies the one or more rigid transformations to each 3D Gaussian included in the deformed 3D Gaussians received from trained implicit deformation MLP 420 and generates 3D Gaussian representation 430.

In step 510, projection renderer 440 of inference engine 124 generates a 2D representation 450 of a 3D scene represented by 3D Gaussian representation 430, based on a virtual camera viewpoint included in control and viewpoint inputs 400. A viewpoint includes a location in world space associated with a virtual camera, and a viewing direction from the virtual camera to a location included in the 3D scene. In various embodiments, the viewing direction may include horizontal and vertical angular displacements describing an orientation relative to a default orientation, e.g., a default viewing direction from the virtual camera to a geometric center of the 3D scene.

In various embodiments, 2D representation 450 may include a 2D raster image depicting the 3D scene as viewed from the virtual camera viewpoint included in control and viewpoint inputs 400. 2D representation 450 may depict a single frame included in a novel performance of an actor generated by inference engine 124. Inference engine 124 may store 2D representation 450 in, e.g., storage 114, prior to processing the next per-frame inputs included in control and viewpoint inputs 400.

In step 512, inference engine 124 generates output sequence 460 based on multiple instances of 2D representation 450 that have been previously generated and stored by inference engine 124. Inference engine 124 generates, for each instance of 2D representation 450, a single frame included in output sequence 460. Output sequence 460 includes an animated sequence depicting the actor for whom trained dynamic state encoder 410 and trained implicit deformation MLP 420 have been previously trained as discussed above in the description of FIG. 2. Each frame included in output sequence 460 depicts both primary and secondary motion of the actor based on the per-frame kinematic control inputs and per-frame camera viewpoint included in control and viewpoint inputs 400.

In various embodiments, inference engine 124 may process multiple per-frame primary motion control inputs and virtual camera viewpoints included in control and viewpoint inputs 400. Consequently, inference engine 124 may repeatedly execute one or more of steps 502, 504, 506, 508, 510, or 512 included in method 500.

In sum, the disclosed techniques predict both quasi-static primary motion and time-dependent dynamic secondary motion associated with a 3D character model represented via a collection of 3D Gaussian splats or primitives. The disclosed techniques determine, via a machine learning model, a dynamic state associated with the 3D character model based on kinematic control inputs, such as joint or limb movements, simulated muscle actuations, or the application of one or more blend shapes to the 3D character model. Based on the determined dynamic state, the disclosed techniques determine, via a different machine learning model, one or more deformations in a 3D canonical space associated with one or more Gaussian splats included in the collection of Gaussian splats. The disclosed techniques perform one or more rigid transformations on the deformed 3D Gaussian splats to convert 3D canonical coordinates associated with the deformed 3D Gaussian splats into corresponding 3D world space coordinates. The disclosed techniques may generate novel 2D depictions of the 3D character model based on arbitrary camera viewpoints associated with real or virtual cameras.

In operation, a training engine modifies one or more adjustable internal parameters associated with a dynamic state encoder machine learning model and an implicit deformation machine learning model, based on a training data set. The training data set includes multiple frames, where each frame includes multi-view video observations of a 3D character model. In various embodiments, the 3D character model may represent a full body, a head, or a face. The training data set also includes per-frame known dynamic kinematic controls associated with a quasi-static configuration of the 3D character model, such as a skull location or a facial expression.

The dynamic state encoder receives a vector zₜ of dynamic kinematic controls associated with a particular frame t. The vector zₜ includes dynamic controls ci for each frame i of n previous frames, such that zₜ=[c0, c1, c2, . . . cn]. Based on the input vector zₜ, the dynamic state encoder predicts a dynamic state yₜ associated with frame t. Because input vector zₜ includes a history of per-frame quasi-stationary configurations of the 3D character model, the dynamic state encoder may predict a description of the dynamic motion of the 3D character model, including secondary motion effects. In various embodiments, the dynamic state encoder may include a multilayer perceptron (MLP) machine learning model, a transformer network machine learning model, or a recurrent neural network (RNN) machine learning model.

The implicit deformation machine learning model receives the dynamic state yₜ associated with frame t from the dynamic state encoder. The implicit deformation machine learning model also receives, from a multi-view video observation, a depiction associated with frame t. The depiction is expressed as a collection of 3D Gaussian splats, where each Gaussian splat includes a corresponding position p, scale s, rotation r, color c, and opacity o.

The implicit deformation machine learning model predicts, for a frame t+1, per-Gaussian deformations ∂x associated with each Gaussian splat included in the collection of Gaussian splats, based on the dynamic state yt associated with previous frame t and the position pi associated with the Gaussian splat. The implicit deformation machine learning model projects position pi into a higher-dimensional latent space via an embedding network. The implicit deformation machine learning model sequentially processes the higher-dimensional latent space embedding and the dynamic state yt through multiple linear layers and activation functions included in the implicit deformation machine learning model. Each of the multiple linear layers receives the output of the previous linear layer, as well as dynamic state yt. A final linear layer and output activation function generate the predicted deformations ∂x corresponding to frame t+1 and associated with the Gaussian splat. The output of the implicit deformation machine learning model includes a collection of deformed 3D Gaussian splats in canonical space. The training engine performs one or more rigid transformations of the

deformed 3D Gaussian splats and generates a collection of deformed 3D Gaussian splats in world space. The training engine projects the collection of deformed 3D Gaussian splats in world space onto one or more image planes corresponding to one or more cameras included in a multi-view video supervision system. The training engine compares the one or more projections to ground truth images included in the training dataset and calculates one or more loss function values. Based on the calculated loss function values, the training engine modifies one or more adjustable internal parameters included in the dynamic state encoder, the embedding network, and/or the implicit deformation machine learning model. The training engine may continue to iteratively modify the one or more adjustable internal parameters for a predetermined number of iterations, or until the one or more loss function values are below one or more predetermined thresholds. The training engine transmits the trained dynamic state encoder and the trained implicit deformation machine learning model to an inference engine.

At inference time, the inference engine may generate novel 3D performances of the actor on which the dynamic state encoder and the trained implicit deformation machine learning model were previously trained. The inference engine receives per-frame novel skull velocities, facial expression encodings, and/or rigid skull transformations. These per-frame control inputs may be generated by hand, reconstructed from a different video of the same actor, or obtained from a video recording of a different actor. For each frame of the novel performance, the inference engine generates a collection of 3D Gaussian splats representing the actor, where the representation includes both quasi-static primary motion and dynamic secondary motion. The inference engine may generate arbitrary 2D views of the novel 3D performance based on camera viewpoints associated with one or more real or virtual cameras.

One technical advantage of the disclosed techniques relative to the prior art is that the disclosed techniques are operable to predict both primary and secondary motion associated with a 3D character model. Further, the disclosed techniques include one or more machine learning models that incorporate time-varying hidden states representing historical dynamic kinematic control inputs, allowing for more accurate prediction of dynamic secondary motion over longer time scales. These technical advantages provide one or more improvements over prior art approaches.
1. In some embodiments, a computer-implemented method for predicting motion in a 3D model, the computer-implemented method comprises receiving one or more Gaussian primitives representing a 3D scene including one or more objects, receiving one or more control inputs describing one or more primary motions associated with the one or more objects, generating, via a first trained machine learning model, a dynamic state based on the one or more control inputs, generating, via a second trained machine learning model, one or more deformed Gaussian primitives based on the dynamic state and the one or more Gaussian primitives, generating, via a renderer, a 2D representation of the 3D scene based on the one or more deformed Gaussian primitives and a virtual camera viewpoint, and generating an output sequence based at least on the 2D representation, wherein the output sequence depicts both the one or more primary motions associated with the one or more objects and one or more secondary motions associated with the one or more objects.
2. The computer-implemented method of clause 1, wherein the first trained machine learning model includes one of a multilayer perceptron (MLP) network, a transformer network, a recurrent neural network (RNN), or a long short-term memory (LSTM) network.
3. The computer-implemented method of clauses 1 or 2, wherein the second trained machine learning model includes an embedding network and one or more sequential linear layers each including an activation function.
4. The computer-implemented method of any of clauses 1-3, further comprising translating locations associated with each of the one or more deformed Gaussian primitives from a canonical coordinate space into a world coordinate space.
5. The computer-implemented method of any of clauses 1-4, wherein the 3D model includes a 3D character model, the one or more objects include at least an actor's face, head, or full body, and the one or more primary motions include movements associated with the actor's face, head, or full body.
6. The computer-implemented method of any of clauses 1-5, wherein the one or more secondary motions depict movement of flexible or otherwise deformable features associated with the actor's face, head, or full body.
7. The computer-implemented method of any of clauses 1-6, wherein the 3D model includes a 3D character model, the one or more objects include at least an actor's face, head, or full body, and each of the one or more control inputs includes a rigid transformation or encoded facial expression associated with the actor's face, head, or full body.
8. The computer-implemented method of any of clauses 1-7, wherein the second trained machine learning model generates, for each of the one or more Gaussian primitives, one or more modifications to parameters associated with the Gaussian primitive.
9. The computer-implemented method of any of clauses 1-8, wherein the one or more control inputs are reconstructed from a recorded video performance of an actor.
10. The computer-implemented method of any of clauses 1-9, wherein each of the Gaussian primitives includes parameters describing a position, rotation, scale, color and opacity associated with the Gaussian primitive.
11.In some embodiments, one or more non-transitory computer-readable media containing instructions that, when executed by one or more processors, cause the one or more processors to perform the steps of receiving one or more Gaussian primitives representing a 3D scene including one or more objects, receiving one or more control inputs describing one or more primary motions associated with the one or more objects, generating, via a first trained machine learning model, a dynamic state based on the one or more control inputs, generating, via a second trained machine learning model, one or more deformed Gaussian primitives based on the dynamic state and the one or more Gaussian primitives, generating, via a renderer, a 2D representation of the 3D scene based on the one or more deformed Gaussian primitives and a virtual camera viewpoint, and generating an output sequence based at least on the 2D representation, wherein the output sequence depicts both the one or more primary motions associated with the one or more objects and one or more secondary motions associated with the one or more objects.
12. The one or more non-transitory computer-readable media of clause 11, wherein the first trained machine learning model includes one of a multilayer perceptron (MLP) network, a transformer network, a recurrent neural network (RNN), or a long short-term memory (LSTM) network.
13. The one or more non-transitory computer-readable media of clauses 11 or 12, wherein the second trained machine learning model includes an embedding network and one or more sequential linear layers each including an activation function.
14. The one or more non-transitory computer-readable media of any of clauses 11-13, further comprising translating locations associated with each of the one or more deformed Gaussian primitives from a canonical coordinate space into a world coordinate space.
15. The one or more non-transitory computer-readable media of any of clauses 11-14, wherein the one or more objects include at least an actor's face, head, or full body, and the one or more primary motions include movements associated with the actor's face, head, or full body.
16. The one or more non-transitory computer-readable media of any of clauses 11-15, wherein the one or more secondary motions depict movement of flexible or otherwise deformable features associated with the actor's face, head, or full body.
17. The one or more non-transitory computer-readable media of any of clauses 11-16, wherein the one or more objects include at least an actor's face, head, or full body, and each of the one or more control inputs includes a rigid transformation or encoded facial expression associated with the actor's face, head, or full body.
18. The one or more non-transitory computer-readable media of any of clauses 11-17, wherein the second trained machine learning model generates, for each of the one or more Gaussian primitives, one or more modifications to parameters associated with the Gaussian primitive.
19.In some embodiments, a system comprises one or more memories storing instructions, and one or more processors for executing the instructions to receive one or more Gaussian primitives representing a 3D scene including one or more objects, receive one or more control inputs describing one or more primary motions associated with the one or more objects, generate, via a first trained machine learning model, a dynamic state based on the one or more control inputs, generate, via a second trained machine learning model, one or more deformed Gaussian primitives based on the dynamic state and the one or more Gaussian primitives, generate, via a renderer, a 2D representation of the 3D scene based on the one or more deformed Gaussian primitives and a virtual camera viewpoint, and generate an output sequence based at least on the 2D representation, wherein the output sequence depicts both the one or more primary motions associated with the one or more objects and one or more secondary motions associated with the one or more objects.
20. The system of clause 19, wherein the one or more objects include at least an actor's face, head, or full body, and each of the one or more control inputs includes a rigid transformation or encoded facial expression associated with the actor's face, head, or full body.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for predicting motion in a 3D model, the computer-implemented method comprising:
receiving one or more Gaussian primitives representing a 3D scene including one or more objects;
receiving one or more control inputs describing one or more primary motions associated with the one or more objects;
generating, via a first trained machine learning model, a dynamic state based on the one or more control inputs;
generating, via a second trained machine learning model, one or more deformed Gaussian primitives based on the dynamic state and the one or more Gaussian primitives;
generating, via a renderer, a 2D representation of the 3D scene based on the one or more deformed Gaussian primitives and a virtual camera viewpoint; and
generating an output sequence based at least on the 2D representation, wherein the output sequence depicts both the one or more primary motions associated with the one or more objects and one or more secondary motions associated with the one or more objects.

2. The computer-implemented method of claim 1, wherein the first trained machine learning model includes one of a multilayer perceptron (MLP) network, a transformer network, a recurrent neural network (RNN), or a long short-term memory (LSTM) network.

3. The computer-implemented method of claim 1, wherein the second trained machine learning model includes an embedding network and one or more sequential linear layers each including an activation function.

4. The computer-implemented method of claim 1, further comprising translating locations associated with each of the one or more deformed Gaussian primitives from a canonical coordinate space into a world coordinate space.

5. The computer-implemented method of claim 1, wherein the 3D model includes a 3D character model, the one or more objects include at least an actor's face, head, or full body, and the one or more primary motions include movements associated with the actor's face, head, or full body.

6. The computer-implemented method of claim 5, wherein the one or more secondary motions depict movement of flexible or otherwise deformable features associated with the actor's face, head, or full body.

7. The computer-implemented method of claim 1, wherein the 3D model includes a 3D character model, the one or more objects include at least an actor's face, head, or full body, and each of the one or more control inputs includes a rigid transformation or encoded facial expression associated with the actor's face, head, or full body.

8. The computer-implemented method of claim 1, wherein the second trained machine learning model generates, for each of the one or more Gaussian primitives, one or more modifications to parameters associated with the Gaussian primitive.

9. The computer-implemented method of claim 1, wherein the one or more control inputs are reconstructed from a recorded video performance of an actor.

10. The computer-implemented method of claim 1, wherein each of the Gaussian primitives includes parameters describing a position, rotation, scale, color and opacity associated with the Gaussian primitive.

11. One or more non-transitory computer-readable media containing instructions that, when executed by one or more processors, cause the one or more processors to perform the steps of:
receiving one or more Gaussian primitives representing a 3D scene including one or more objects;
receiving one or more control inputs describing one or more primary motions associated with the one or more objects;
generating, via a first trained machine learning model, a dynamic state based on the one or more control inputs;
generating, via a second trained machine learning model, one or more deformed Gaussian primitives based on the dynamic state and the one or more Gaussian primitives;
generating, via a renderer, a 2D representation of the 3D scene based on the one or more deformed Gaussian primitives and a virtual camera viewpoint; and
generating an output sequence based at least on the 2D representation, wherein the output sequence depicts both the one or more primary motions associated with the one or more objects and one or more secondary motions associated with the one or more objects.

12. The one or more non-transitory computer-readable media of claim 11, wherein the first trained machine learning model includes one of a multilayer perceptron (MLP) network, a transformer network, a recurrent neural network (RNN), or a long short-term memory (LSTM) network.

13. The one or more non-transitory computer-readable media of claim 11, wherein the second trained machine learning model includes an embedding network and one or more sequential linear layers each including an activation function.

14. The one or more non-transitory computer-readable media of claim 11, further comprising translating locations associated with each of the one or more deformed Gaussian primitives from a canonical coordinate space into a world coordinate space.

15. The one or more non-transitory computer-readable media of claim 11, wherein the one or more objects include at least an actor's face, head, or full body, and the one or more primary motions include movements associated with the actor's face, head, or full body.

16. The one or more non-transitory computer-readable media of claim 15, wherein the one or more secondary motions depict movement of flexible or otherwise deformable features associated with the actor's face, head, or full body.

17. The one or more non-transitory computer-readable media of claim 11, wherein the one or more objects include at least an actor's face, head, or full body, and each of the one or more control inputs includes a rigid transformation or encoded facial expression associated with the actor's face, head, or full body.

18. The one or more non-transitory computer-readable media of claim 11, wherein the second trained machine learning model generates, for each of the one or more Gaussian primitives, one or more modifications to parameters associated with the Gaussian primitive.

19. A system comprising:
one or more memories storing instructions; and
one or more processors for executing the instructions to:
receive one or more Gaussian primitives representing a 3D scene including one or more objects;
receive one or more control inputs describing one or more primary motions associated with the one or more objects;
generate, via a first trained machine learning model, a dynamic state based on the one or more control inputs;
generate, via a second trained machine learning model, one or more deformed Gaussian primitives based on the dynamic state and the one or more Gaussian primitives;
generate, via a renderer, a 2D representation of the 3D scene based on the one or more deformed Gaussian primitives and a virtual camera viewpoint; and
generate an output sequence based at least on the 2D representation, wherein the output sequence depicts both the one or more primary motions associated with the one or more objects and one or more secondary motions associated with the one or more objects.

20. The system of claim 19, wherein the one or more objects include at least an actor's face, head, or full body, and each of the one or more control inputs includes a rigid transformation or encoded facial expression associated with the actor's face, head, or full body.
